(19) United States
(12) Patent Application Publication
(10) Pub. No.: US 2023/0318701 A1
(43) Pub. Date: Oct. 5, 2023

(54) Methods and Apparatus for Fault Tolerance in Multi-Wavelength Optical Interconnect Networks

(71) Applicant: Fathom Radiant, PBC, Boulder, CO (US)

(72) Inventors: Soheil Hashemi, Broomfield, CO (US); Ryan Boesch, Louisville, CO (US); David R. Thomas, Boulder, CO (US)

(21) Appl. No.: 18/193,549

(22) Filed: Mar. 30, 2023

Related U.S. Application Data
(60) Provisional application No. 63/326,193, filed on Mar. 31, 2022.

(51) Int. Cl. H04B 10/032; H04B 10/075; H04J 14/02

(52) U.S. Cl. CPC H04B 10/032; H04B 10/075; H04J 14/02

(57) ABSTRACT

Systems and methods for enabling robust fault tolerance targeting runtime failures in multi-wavelength optical links. The proposed embodiment relies on built-in lane redundancy where failure can be detected and repaired during runtime and in an online fashion. Features allow out-of-band and side-band communication.

This application relates to U.S. patent application Ser. No. ______, titled “Redundant Transmission and Receive Elements for High-Bandwidth Communication” by inventors Ryan Boesch, J. Israel Ramirez, and Keith Behrman, and filed concurrently herewith, which application is hereby incorporated herein by reference.

This application claims the benefit of U.S. Patent Application 63/326,193, filed 31 Mar. 2022 and incorporates it herein by reference.

### BACKGROUND OF THE INVENTION

### Field of the Invention

The present invention relates to enabling robust and online fault tolerance in optical interconnection networks. In particular, the present invention relates to methods and apparatus for lane fault tolerance in parallel surface-normal multi-wavelength optical interconnect networks.

### Discussion of Related Art

Fault tolerance is an important consideration in any communication system, and particularly in optical networks where transmission errors can result in significant data loss. As such, numerous approaches have been proposed to improve fault tolerance in optical networks. One approach to improving fault tolerance is through the use of redundant lanes, carried by redundant wavelengths. Redundancy provides a mechanism for maintaining system functionality in the event of failures or errors. This can be achieved through the use of standby lanes, which are activated in the event of failure on the primary lane, or through the use of parallel lanes that provide alternative pathways for data transmission.

### SUMMARY OF THE INVENTION

The use of built-in lane redundancy improves fault tolerance in parallel multi-wavelength surface-normal optical links. The redundant lanes are coupled into a single fiber core through an integrated and compact surface-normal multiplexer. This technique reduces the cost, area, and power penalties accrued for the redundant lanes.

Systems utilize a multitude of redundant wavelengths, corresponding to redundant optical elements and lanes, as a failover mechanism. A detection and isolation logic pinpoints the faulty lane, and an online failover approach ensures the faulty lane's data is routed to a redundant lane. Features include out-of-band and side-band communication of the fault information.

Apparatus for detecting and repairing faults in an optical communication system has spaced apart nodes connected by an optical fiber. Each node has an optical engine comprising multiple optical transmitters and multiple optical receivers including a redundant transmitter and a redundant receiver, as well as a wavelength multiplexer/demultiplexer and link control circuitry. The optical transmitters emit at differing wavelengths and are coupled into the optical fiber through the wavelength multiplexer/demultiplexer, and additional wavelengths are demultiplexed from the optical fiber to the optical receivers through the wavelength multiplexer/demultiplexer. A lane is a transmitter at an optical engine at a first node, the optical fiber, and a receiver at an optical engine at a second node.

The link control circuitry is configured to detect faulty lanes in real time while the apparatus is communicating. Link control circuitry at the first node and link control circuitry at the second node communicate with each other to identify the faulty lane, send data to the redundant lane, deskew the redundant lane data, and turn off the faulty lane. Multiple lanes may designated as redundant lanes to replace multiple faulty lanes.

The optical multiplexer/demultiplexers can be thin-film filter zig-zag multiplexer/demultiplexers with some filter bands reserved for redundant wavelengths. In some embodiments, the optical engines has two or more links, and each link has multiple optical transmitters and multiple optical receivers including a redundant transmitter and a redundant receiver, and link control circuitry. For example, an embodiment may include 32 links.

The optical transmitters and optical receivers may be surface normal to the optical engine. The optical transmitters and optical receivers might be directly integrated on a silicon logic layer of an optical engine comprising physical and data link layers. In some embodiments, the optical transmitters are vertical-cavity surface-emitting lasers with cavities tuned for wavelengths partitioned across a wavelength band, some of those wavelengths being redundant and the receivers are broadband photodetectors responsive across the wavelength band.

A method of detecting and repairing faults in an optical communication system having nodes spaced apart from each other and connected via an optical fiber, includes providing at each node an optical engine comprising multiple primary optical transmitters and multiple primary optical receivers, one redundant optical transmitter and one redundant optical receiver, link control circuitry, and a wavelength multiplexer/demultiplexer, providing multiple primary lanes between the nodes, wherein a lane is defined as a primary transmitter at an optical engine at a far-side node, the optical fiber, and a primary receiver at an optical engine at a near-side node, communicating between the nodes via the primary lanes, transmitting from optical transmitters at differing wavelengths, coupling the differing wavelength transmissions into the optical fiber via the wavelength multiplexer/demultiplexer, demultiplexing the differing wavelength transmissions from the optical fiber to the optical receivers via the wavelength multiplexer/demultiplexer, monitoring communication and detecting faulty primary lanes while communicating.

Once faulty lane is detected, it is identified at the near-side receiver of the faulty primary lane. Next is failover event communication of the faulty primary lane from the near-side of the faulty primary lane to the far-side of the faulty primary lane. A redundant lane is created using a redundant transmitter adjacent to the primary transmitter of the faulty lane and a redundant receiver adjacent to the primary receiver of the faulty lane. While communication continues, including on the faulty lane, the redundant lane is trained.

Data from the faulty link is used to deskew the redundant lane. For example, the data sent on the redundant lane can mirror the data sent on the faulty lane. Once the redundant lane is deskewed, the faulty lane can be taken offline.

Detecting a faulty lane evaluates communication errors, for example retry logs. Or error counts, an eye scan, or analog to digital converter (ADC) histogram may be used.

The failover event communicating step can be performed using an idle redundant transmitter as sideband or using an out-of-band fabric manager.

### BRIEF DESCRIPTION OF THE DRAWINGS

FIG. 1 is a schematic side view of the end-to-end surface-normal optical link, utilizing wavelength division multiplexing (WDM).

FIG. 2A is an isometric view depiction of the optical engine with redundant elements.

FIG. 2B shows one configuration of optical elements.

FIG. 3 is an example of 2 nodes connected through an example link, where a failure is detected on the near-side node. The out-of-band management fabric is shown.

FIG. 4 is a flowchart showing online detection and repair methodology.

### DETAILED DESCRIPTION OF THE INVENTION

TABLE 1

| | |
|---|---|
| 100 | Carrier board or substrate |
| 110 | Link end-points |
| 110A | Near side link end-point |
| 110B | Far side link end-point |
| 120 | Electrical channel |
| 130 | Fabric manager |
| 135 | Out-of-band management fabric |
| 150 | Optical engine IC (OE) |
| 150A | Near side OE |
| 150B | Far side OE |
| 151 | Data interface |
| 152 | Per-link link control logic |
| 153 | Individual link |
| 154 | Optical element (transmit or receive) |
| 155 | Transmit optical element |
| 156 | Receive optical element |
| 157 | Redundant transmit element |
| 158 | Redundant receive element |
| 159 | Redundant lanes |
| 160 | Primary lanes |
| 170 | Node |
| 200 | Optical multiplexer/demultiplexer |
| 250 | Optical fiber |
| 500 | Initial link training |
| 502 | Normal operation |
| 504 | Failure detected? |
| 506 | Identify faulty lane |
| 508 | Signal to link partner to begin switching the problem lane to |
| | the redundant |
| 510 | Redundant lane training |
| 512 | Link partner mirrors data from problem lane to redundant |
| | lane, deskew redundant lane with this information |
| 514 | Link partner disables problem lane transmitter |

Table 1 lists elements of the present invention and their corresponding reference numbers.

FIG. 1 is a high-level depiction of an end-to-end optical link, where collection of the optical links as depicted form an optical interconnect. Two communicating nodes 170 communicate optically through optical fibers 250. In each node an end-point 110 communicates to optical engines 150 through short channel electrical interconnects 120. Depending on the integration, the electrical channel can be on printed circuit board (PCB), on-board integration, or through an integrated chip packaging substrate, Co-packaged. In one preferred embodiment of the present invention, the optical engine 150 utilizes optical elements 154 tuned to a multitude of wavelengths multiplexed and carried over a single fiber 250. In a preferred embodiment, vertical-cavity surface-emitting lasers (VCSEL) with cavities tuned for wavelengths partitioned across a wavelength band and broadband photodetectors (PD) responsive across the wavelength band are mass-transferred and integrated on top of the logic silicon. A subset of available wavelengths are designated as redundant. An optical multiplexer 200 is utilized to couple the different wavelengths, including the redundant, into a signal core fiber. In the preferred embodiment the optical multiplexer/demultiplexer is implemented as a thin-film filter zig-zag with some filter bands reserved for redundant wavelengths. The collection of a transmitter element 155, the fiber 250, and a receive element 156 forms an individual unidirectional lane. The optical multiplexer multiplexes multiple lanes in each direction into a single fiber.

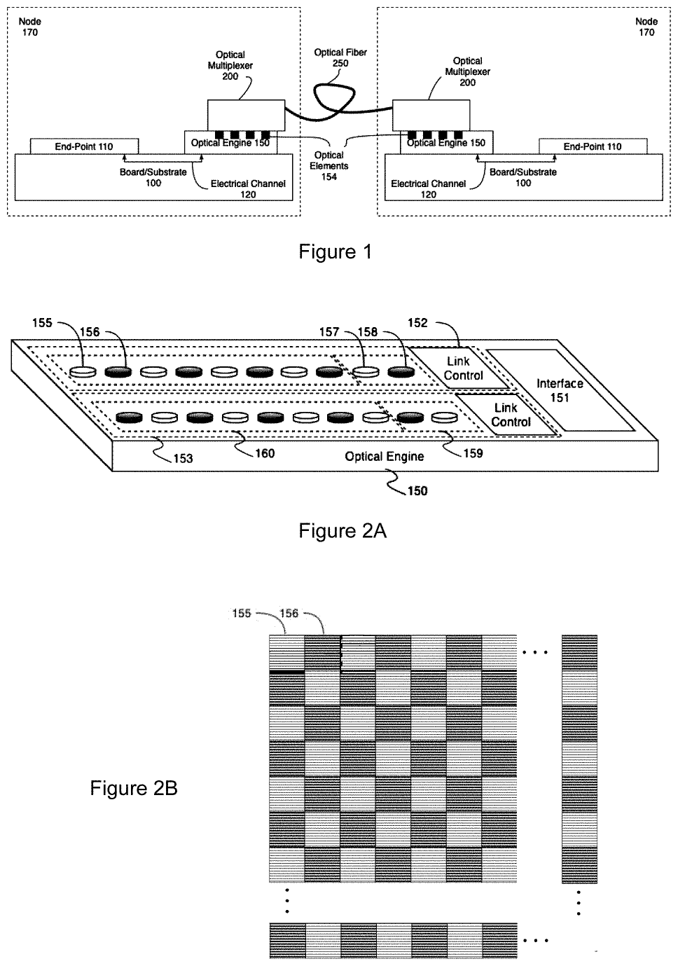

FIG. 2 shows a preferred embodiment of the optical engine 150, and the components enabling the realization of the fault tolerance through redundancy. A link 153 comprises multiple transmit 155 and receive 156 elements, integrated onto the logic silicon, and a link controller 152. Redundant transmit 157 and receive 158 elements are also integrated in each link 153, where the redundant elements are dormant until a fault in the link is detected. In the embodiment of FIG. 2 each link consists of four primary lanes 160 in each direction, two redundant lanes 159 one in each direction, and two links 153. In one useful embodiment shown in FIG. 2B, the transmit and receive elements are organized in a checkerboard pattern. Alternative realizations are possible. Generally more links 153 would be used for greater communication bandwidth, for example 32 links or 64 links. Additional redundant lanes within each link 153 can also be provided in case more than one faulty primary lane needs to be replaced.

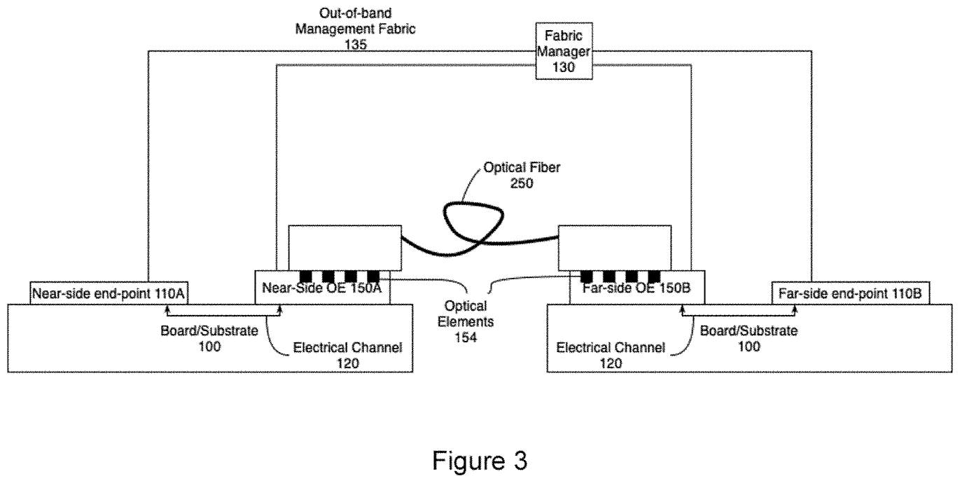

In FIG. 2, an electrical interface 151 feeds/sinks the data into/from the individual links 153. The link control logic 152 contains the logic necessary to isolate faulty lanes at runtime, and perform the online failover of the presented invention. FIG. 3 shows an example of a process implemented by link control 152.

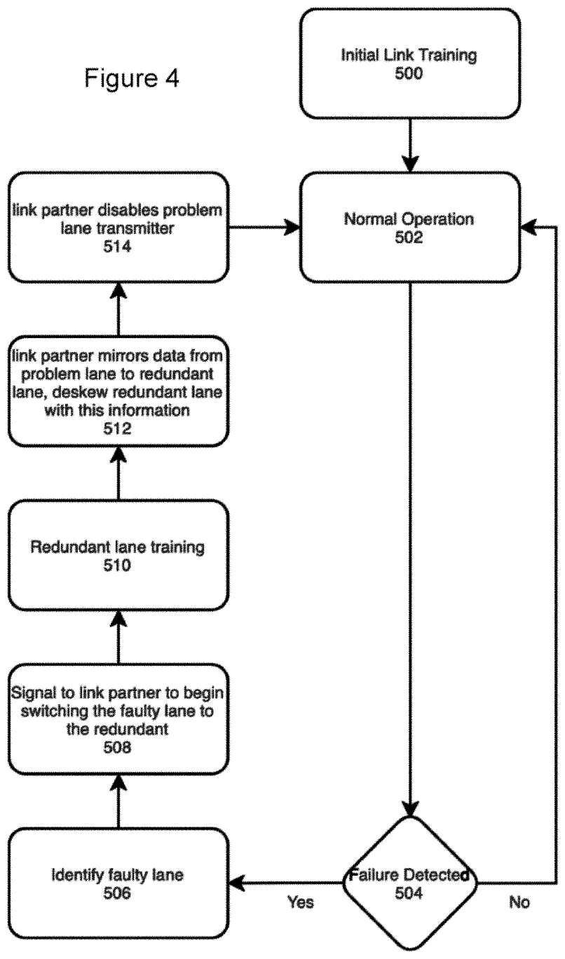

FIG. 3 shows an example of an optical link where a lane failure is detected on the near-side end-point 110A (see FIG. 4). The figure also shows the fabric manager 130 and the management fabric 135. The side where a fault event is detected is referred to as near-side, while the link partner on the other side of the optical fiber 250 is referred to as far-side.

FIG. 4 shows a methodology for online fault detection and failover to redundant elements. Upon powerup, the link is trained in step 500 and moved to normal operation in step 502. If a lane failure is detected in step 504, the link controller 152 identifies the faulty lane in step 506 and instructs the link partner on the far-side OE 1508 to initiate training 508 on one of the available redundant lanes 159. In a preferred embodiment, the end-point 110A flags the occurrence of a lane fault, based on an unexpectedly large count of errors/retries. A fault is flagged to the respective link controller 152 of the near-side optical engine 150A if the count increases above a threshold. The link controller 152 then identifies the faulty lane by triggering an isolation step 506. In different embodiments, the metric used for isolation could be an eye-scan or a histogram such as an analog to digital converter (ADC) histogram. One of the idle far-side redundant transmitters 157 is then instructed to prepare for operation in step 508 by initiating the redundant lane training in step 510. The communication to the far-side link partner can be executed out-of-band through a management fabric 135, or by utilizing one of the idle redundant transmitters 157 on the near-side OE 150A as a side channel.

Following lane training, in step 512 the selected far-side redundant transmitter 157 switches to mirroring the faulty lane data, enabling the receiver to deskew the redundant lane. Finally the faulty lane is turned off in step 514 and the link resumes normal operation 502.

We claim:

1. Apparatus for detecting and repairing faults in an optical communication system comprising:
spaced apart nodes connected by an optical fiber;
each node having an optical engine comprising multiple optical transmitters and multiple optical receivers including a redundant transmitter and a redundant receiver, wavelength multiplexer/demultiplexer, and link control circuitry;
wherein the optical transmitters emit at differing wavelengths and are coupled into the optical fiber through the wavelength multiplexer/demultiplexer, and additional wavelengths are demultiplexed from the optical fiber to the optical receivers through the wavelength multiplexer/demultiplexer;
wherein a lane is defined as a transmitter at an optical engine at a first node, the optical fiber, and a receiver at an optical engine at a second node;
wherein link control circuitry is configured to detect a faulty lane while the apparatus is communicating;
wherein link control circuitry at the first node and link control circuitry at the second node are further configured to communicate with each other to identify the faulty lane, send data to the redundant lane, deskew the redundant lane data, and turn off the faulty lane.

2. The apparatus of claim 1 wherein multiple lanes are designated as redundant lanes to replace multiple faulty lanes.

3. The apparatus of claim 1 wherein the optical multiplexer/demultiplexers are thin-film filter zig-zag multiplexer/demultiplexers with some filter bands reserved for redundant wavelengths.

4. The apparatus of claim 1 wherein each optical engine includes two links, each link comprising multiple optical transmitters and multiple optical receivers including a redundant transmitter and a redundant receiver, and link control circuitry.

5. The apparatus of claim 4 wherein each optical engine comprises 32 links.

6. The apparatus of claim 1 wherein the optical transmitters and optical receivers are configured to be surface normal to the optical engine.

7. The apparatus of claim 6 wherein optical transmitters and optical receivers are directly integrated on a silicon logic layer of an optical engine comprising physical and data link layers.

8. The apparatus of claim 6, wherein the optical transmitters are vertical-cavity surface-emitting lasers with cavities tuned for wavelengths partitioned across a wavelength band, some of those wavelengths being redundant; and
wherein the receivers are broadband photodetectors responsive across the wavelength band.

9. A method of detecting and repairing faults in an optical communication system having nodes spaced apart from each other and connected via an optical fiber, the method comprising the steps of:
providing at each node an optical engine comprising multiple primary optical transmitters and multiple primary optical receivers, one redundant optical transmitter and one redundant optical receiver, link control circuitry, and a wavelength multiplexer/demultiplexer;
providing multiple primary lanes between the nodes, wherein a lane is defined as a primary transmitter at an optical engine at a far-side node, the optical fiber, and a primary receiver at an optical engine at a near-side node;
communicating between the nodes via the primary lanes;
transmitting from optical transmitters at differing wavelengths;
coupling the differing wavelength transmissions into the optical fiber via the wavelength multiplexer/demultiplexer;
demultiplexing the differing wavelength transmissions from the optical fiber to the optical receivers via the wavelength multiplexer/demultiplexer;
monitoring communication and detecting faulty primary lanes while communicating;
identifying a faulty primary lane at the near-side receiver of the faulty primary lane;
failover event communication of the faulty primary lane from the near-side of the faulty primary lane to the far-side of the faulty primary lane;
creating a redundant lane using a redundant transmitter on the optical engine containing the primary transmitter of the faulty primary lane and a redundant receiver on the optical engine containing the primary receiver of the faulty primary lane;
training the redundant lane;
sending data from the far-side primary transmitter of the faulty lane on the far-side redundant transmitter of the redundant lane as well;
deskewing the redundant lane based on data at the primary receiver of the faulty primary lane; and
disabling the faulty primary lane after the deskewing step.

10. The method of claim 9 wherein multiple redundant transmitters and redundant receivers are provided to allow multiple redundant lanes to be created;

11. The method of claim 9 wherein the step of detecting a faulty lane evaluates communication errors.

12. The method of claim 11 wherein the step of detecting faulty lanes evaluates retry logs.

13. The method of claim 9 wherein the step of detecting faulty lanes evaluates error counts.

14. The method of claim 9 wherein the step of detecting faulty lanes performs an eye scan.

15. The method of claim 9 wherein the step of detecting faulty lanes utilizes an analog to digital converter (ADC) histogram.

16. The method of claim 9, wherein the failover event communicating step is performed using an idle redundant transmitter as sideband.

17. The method of claim 9, wherein the failover event communicating step is performed using an out-of-band fabric manager.

18. The method of claim 9, wherein, during the deskew step, the data sent on the redundant lane is mirroring the data sent on the faulty lane.
